(19) United States
(12) Patent Application Publication
(10) Pub. No.: US 2015/0010073 A1
(43) Pub. Date: Jan. 8, 2015

(54) Dynamic quantization method for encoding data streams

(71) Applicant: FRANCE BREVETS, Paris (FR)

(72) Inventors: Xavier Ducloux, Rennes (FR); Arnaud Tirel, Rennes (FR); Xavier Besnard, Acigne (FR)

(21) Appl. No.: 14/372,927

(22) PCT Filed: Dec. 21, 2012
(86) PCT No.: PCT/EP2012/076626

§ 371 Date: Jul. 17, 2014

(30) Foreign Application Priority Data
Jan. 17, 2012 (FR) 1250480

(51) Int. Cl. H04N 19/61; H04N 19/124; H04N 19/593

(52) U.S. Cl. CPC H04N 19/00793; H04N 19/00763; H04N 19/0009
USPC 375/240.12

(57) ABSTRACT

The present invention relates to a method of dynamic quantization of a stream of images including blocks (210) of different types transposed into the transform domain, the method comprising a first step of quantization (201) of several of said blocks with initial quantization coefficients (211), the method comprising a step of determination (202), for several types of block respectively, of the residual encoding costs after said first quantization (201), and a second step of quantization (204) of the transposed blocks (210) of at least one type with quantization coefficients chosen (203) according to the distribution of said residual costs between several types of block. The invention applies to encoders comprising a step of quantization capable of applying different quantization coefficients according to the types of block of images to be encoded.

The present invention relates to a dynamic quantization method for encoding data streams. It notably applies to the compression of videos according to the H.264 (as defined by the ITU (International Telecommunication Union) otherwise denoted MPEG4-AVC by the ISO (International Organization for Standardization)) and H.265 standards. More generally, the present invention applies to the encoders comprising a quantization step during which different quantization coefficients can be applied according to the types of block of images to be encoded.

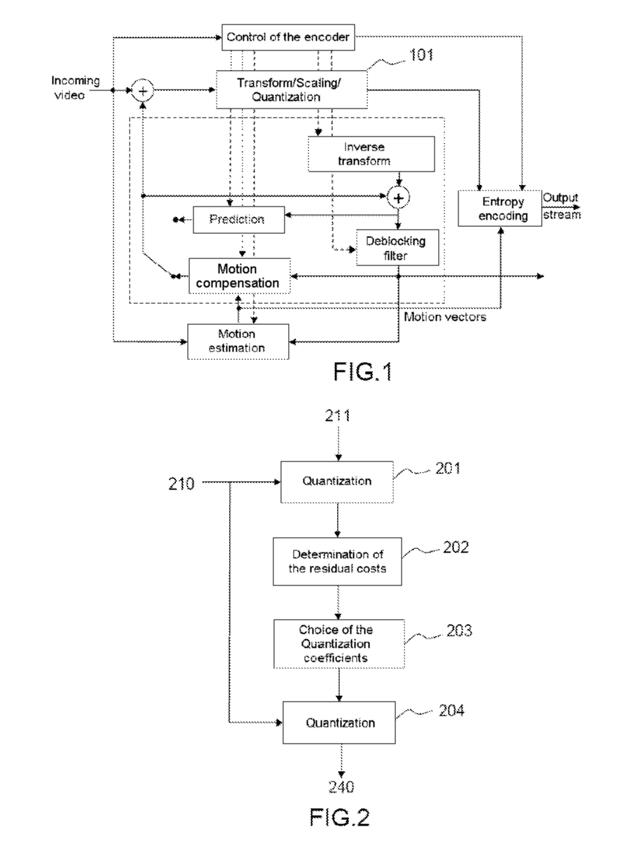

Quantization is a well-known step of MPEG video encoding that makes it possible, after transposition of the image data into the transform domain, to sacrifice the higher-order coefficients to substantially reduce the size of the data while only moderately affecting their visual rendition. Quantization is therefore an essential step of lossy compression. As a general rule, it is also the step that introduces the most considerable artifacts into the encoded video, particularly when the quantization coefficients are very high. FIG. 1 illustrates the place 101 occupied by the quantization step in an encoding method according to the MPEG4-AVC standard.

The encoding complexity and the quantity of information to be conserved to guarantee an acceptable output quality varies over time, according to the nature of the sequences contained in the stream. Known methods make it possible to encode an audio or video stream by controlling the bitrate of the data produced at the output. Some of these methods rely on a double-pass quantization wherein the first pass makes it possible to generate bitrate requests to an allocator as a function of the complexity of the video sequence, the second pass encoding the sequence at the bitrate allocated by the allocator. The quantization level applied in the second pass plays, in this context, the role of a tuning variable allowing the desired bitrate to be attained.

However, at a constant bitrate, the quality of the video can fluctuate to the point of momentarily degrading beyond a visually acceptable level. A means for guaranteeing a minimum level of quality over the whole duration of the stream is then to increase the bitrate, which turns out to be expensive and sub-optimal in terms of hardware resource use.

Variable-bitrate streams can also be generated, the bitrate increasing in relation to the complexity of the scene to be encoded. However, this type of stream is not always in agreement with the constraints imposed by the transport infrastructures. Indeed, it is frequent that a fixed bandwidth be allocated on a transmission channel, consequently forcing the allocation of a bandwidth equal to the maximum bitrate encountered in the stream in order to avoid transmission anomalies. Moreover, this technique produces a stream whose average bitrate is substantially higher, since the bitrate must be increased at least temporarily to preserve the quality of the most complex scenes.

One aim of the invention is to decrease the bandwidth occupied by a stream encoded according to a standard of MPEG type, or to increase the quality of this stream as perceived by the user, with, moreover, equal bitrate. For this purpose, the subject of the invention is a method of dynamic quantization of a stream of images including blocks of different types transposed into the transform domain, the method comprising a first step of quantization of several of said blocks with initial quantization coefficients, the method being characterized in that it comprises a step of determination, for several types of block respectively, of the residual encoding costs after said first quantization, and a second step of quantization of the transposed blocks of at least one type with quantization coefficients chosen according to the distribution of said residual costs between several types of block.

The first quantization step can be considered as a pre-quantization executed with the aim of determining the distribution of the residual costs between different types of block, i.e. for example the ratio of the costs incurred by a first type of block and the costs incurred by a second type of block. This distribution is then used in the second quantization step to oversee the allocation of bitrate between several types of block and/or between the components of the transform domain of one and the same type of block. The initial quantization coefficients can be predetermined to carry out a quantization according to a compromise defined in advance, for example as a function of the transformed image sequences liable to be quantized. The coefficients used for the second quantization step are established according to the distribution of the residual costs and, for example, the psycho-visual criteria defined in advance, in order to minimize the degradation of quality due to quantization while limiting the use of bandwidth during the transport of data.

It should be noted that the quantization coefficients used by the method according to the invention to quantify the transformed macroblocks must not be confused with the quantization parameter, also called mb_qp_delta in the MPEG4-AVC standard, a parameter that is transmitted for each macroblock of the image and that enables the deduction of the overall scalar quantization to be applied to the set of frequency coefficients. Indeed, the dynamic quantization method according to the invention can effect a finer level of tuning, since it is capable of tuning the scalar coefficients for each of the frequency coefficients resulting from the transform.

According to one implementation of the dynamic quantization method according to the invention, a plurality of sets of coefficients are pre-computed and coefficients of a set chosen from among said plurality are applied in the second quantization step. Several configurations can thus be computed in advance, each configuration being associated with a set of quantization coefficients. Advantageously, the coefficients are grouped into matrices, thus forming quantization matrices. One set of matrices among several is then chosen in the second quantization step.

According to one implementation of the dynamic quantization method according to the invention, one indicator or several indicators of distribution of the residual costs between several types of block is computed, the domain of definition of said indicators is partitioned into a plurality of domains of values, a set of pre-computed coefficients is associated to each of said domains, and the set of coefficients to be applied in the second quantization step is chosen from among said sets as a function of the value of said indicators. When a single indicator is computed, the domain of values can be reduced to a plurality of intervals of value.

According to one implementation of the dynamic quantization method according to the invention, the blocks quantized in the first quantization step comprise chrominance blocks and luminance blocks transposed into the transform domain, and the quantization coefficients applied in the second step are chosen at least partly as a function of the ratio of the residual costs due to the chrominance blocks to the residual costs due to the luminance blocks.

In other words, the image blocks are decomposed into a plurality of colorimetric components that are transposed by blocks into the transform domain, and to which pre-quantization coefficients are applied, the distribution of the residual encoding costs of the blocks of the image between the different colorimetric components is determined, the blocks transposed into the transform domain are quantized with coefficients chosen as a function of said distribution. This implementation of the method according to the invention enables better distribution of the bitrate allocated between the chrominance and luminance blocks, but also a refinement of the distribution of the allocated bitrate between the components of the transform domain of one and the same type of block.

According to one implementation of the dynamic quantization method according to the invention, in the second quantization step, the quantization coefficients associated with the lower-order components of the chrominance blocks are decreased, in relation to the decrease in the residual costs due to the chrominance blocks with respect to the residual costs due to the luminance blocks. The term “lower-order components” means the components of low value in the transform domain, in other words the low-frequency components in the frequency domain, for example the components corresponding to a frequency below or equal to a predetermined value.

According to one implementation of the dynamic quantization method according to the invention, the blocks quantized in the first quantization step comprise spatial predictive encoding blocks and temporal predictive encoding blocks transposed into the transform domain, and the quantization coefficients applied in the second step are chosen at least partly as a function of the ratio of the residual costs due to the spatial predictive encoding blocks to the residual costs due to the temporal predictive encoding blocks. In other words, the residual encoding costs at the end of the pre-quantization are determined, separately for each type of intra-image and inter-image encoding (spatial predictive encoding and temporal predictive encoding respectively), then a quantization is applied with separate coefficients for each type of block and these coefficients are determined as a function of said relative encoding costs. “Spatial predictive encoding block” and “temporal predictive encoding block” mean, respectively, “block with an encoding of the spatial predictive type” and “block with an encoding of the temporal predictive type”. They can also be understood to mean, respectively, “block included in an image whose blocks all have spatial predictive encoding” and “block included in an image including blocks with temporal predictive encoding”.

According to one implementation of the dynamic quantization method according to the invention, in the second quantization step, the quantization coefficients associated with the spatial predictive encoding blocks are decreased, and the quantization coefficients associated with the temporal predictive encoding blocks are increased, in relation to the decrease in the residual costs due to the temporal predictive encoding blocks with respect to the residual costs due to the spatial predictive encoding blocks.

According to one implementation of the dynamic quantization method according to the invention, the quantization coefficients applied in the second quantization to a single type of block or to a single set of types of block are grouped and stored in the memory in a quantization matrix.

The stream to be encoded can be of the MPEG standard (for example MPEG4, also known as H.264), and a set of quantization matrices chosen dynamically as a function of the distribution of the residual costs can comprise:
three matrices intended for the quantization of the spatial predictive encoding blocks of a dimension of 4×4 pixels, among which two are intended for the chrominance blocks and one is intended for the luminance blocks;
three matrices intended for the quantization of the temporal predictive encoding blocks of a dimension of 4×4 pixels, among which two are intended for the chrominance blocks and one is intended for the luminance blocks; and
two matrices intended for the quantization of the luminance blocks of a dimension of 8×8 pixels, among which are the spatial predictive encoding blocks and the temporal predictive encoding blocks.

Another subject of the invention is a method for encoding a stream of images forming a video, comprising a step of transforming images by blocks into the transform domain, wherein a dynamic quantization method as described above is executed on said blocks. The stream can be encoded according to an MPEG standard.

According to one implementation of the aforementioned encoding method, the dynamic quantization method is applied cyclically over a reference period equal to one group of MPEG images.

Another subject of the invention is a video encoder, for example MPEG, configured to execute the decoding method as described above.

Another subject of the invention is a method for decoding a stream of images encoded by an MPEG encoder as described above, the decoder being configured to retrieve, from said encoded stream of images, the quantization coefficients used by the encoder to quantize the blocks of data. The quantization matrices can be retrieved in the stream if they have been inserted into it by the encoder, or retrieved by an identifier inserted into the stream, the decoder then including a memory for storing the various quantization matrices liable to be employed.

Another subject of the invention is an MPEG video decoder, configured to execute the encoding method as described above.

Other features will become apparent upon reading the detailed description, given by way of example and in no way limiting, that follows with reference to the appended drawings which represent:

FIG. 1, a block diagram illustrating an encoding method according to the MGEG4-AVC standard wherein the method according to the invention can be employed, this figure having already been shown above;

FIG. 2, a block diagram illustrating an example of a dynamic quantization method according to the invention.

The non-limiting example developed below is that of the quantization of a stream of images to be encoded according to the H.264/MPEG4-AVC standard.

FIG. 2 shows a block diagram illustrating an example of a dynamic quantization method according to the invention. The latter comprises a first step of quantization 201, a step of determination 202 of the relative residual costs of encoding, a step of choice 203 of the quantization coefficients, and a second step of quantization 204 making use of the coefficients chosen previously.

Prior to the execution of the dynamic quantization method according to the invention, the images to be encoded are divided into macroblocks. Each macroblock corresponds to a portion of an image and is decomposed into a plurality of components, according to a chosen colorimetric system. Thus, a macroblock of the H.264 standard can be defined as a combination of blocks including the luminance and chrominance information. According to the chroma sampling formats (4:2:0, 4:2:2 for example), the chrominance blocks are of different dimensions. In the example, the macroblocks have a size of 16×16 pixels. These macroblocks are composed of blocks of 8×8 or 4×4 pixels comprising the luminance and chrominance information. The blocks are transformed into the transform domain by a DCT (Discrete Cosine Transform) with the aim of effecting a visually acceptable compression by quantization. Among these blocks, some are encoded according to a spatial predictive encoding mode (also described by the term “intra” to signify that the encoding does not depend on any image other than that in which the block is situated), others according to a predictive mode (also described by the term “inter” to designate the blocks whose encoding depends on at least one other image than that in which it is situated).

Firstly, the blocks 210 resulting from the step of transformation into the transform domain are subject to a first quantization 201 in order to measure the residual costs of encoding. Residual values of transformed components are obtained at the end of this first quantization 201, so that for each quantized block, it is possible to determine the residual encoding cost, in other words the number of bits necessary for encoding the residual values after quantization. At the end of this first quantization, the residual encoding costs for each type (or category) of block are therefore obtained: chrominance block, luminance block, block encoded in intra mode, block encoded in inter mode, for example.

These examples of types are non-limiting and can notably depend on the system chosen for decomposing the macroblocks into a plurality of informational components (in the example, the colorimetric system used is YUV, “Y” representing the luminance component, “U” and “V” representing the chrominance components). The types of block can be considered as crossing several categories amongst themselves: for example a block of intra type can at the same time be a block of chrominance type; the residual encoding costs can then be considered for blocks of “intra-chrominance” type. It is thus possible to divide the space into types of block according to multiple possibilities, another example consisting in considering only two types of block: a first type, for example the luminance blocks encoded in intra, and a second type grouping together all the other possible categories of blocks.

It is also possible to consider only the encoding costs incurred by certain types of block while ignoring those caused by others. For example, it is possible to consider only the residual costs of inter and intra blocks, without measuring the costs related to chrominance and luminance blocks. Moreover, according to one implementation of the method according to the invention, the classification of the blocks into different types can depend on the type of image to which this block belongs. For example, MPEG images of P type (with temporal prediction) and B type (with bidirectional prediction) for the most part include temporal predictive encoding blocks. However, the latter can also include spatial predictive encoding blocks. The type of block considered for the computation of the residual costs as being that of the type of the image to which this block belongs, so that a block with spatial predictive encoding present in an image (B or P) whose encoding is for the most part temporal predictive is considered as participating in the residual costs of the images of inter type, therefore considered as “inter” type. This makes it possible to distribute the residual costs as a function of the type of the image (I or B/P) to be encoded.

Preferably, the initial coefficients 211 chosen for quantizing the data in this first quantization 201 differ according to the type of block. In the example, a matrix of quantization by type of block is used. Thus, in the example relating to the H.264/MPEG4-AVC standard, eight different matrices can be defined:
six matrices for the blocks of a dimension of 4×4 pixels: one for the blocks of Intra 4×4 Y (luminance) type, one for the blocks of Intra 4×4 Chroma U (Chrominance U) type, one for the blocks of Intra 4×4 Chroma V type, one for the blocks of Inter 4×4 Y type, one for the blocks of Inter 4×4 Chroma U type, and one for the blocks of Inter 4×4 Chroma V type;
two matrices for the blocks of a dimension of 8×8 pixels: one for the blocks of Intra 8×8 Y type, and one for the blocks of Inter 8×8 Y type.
   It should be noted that the types of block being considered in the computation of the residual encoding costs can be decoupled from the types associated with the quantization matrices. In other words, the space of the types of block can be partitioned differently from the way in which the quantization matrices are distributed (the latter can notably depend on the standard of encoding used). For example, one could use only two types of quantization matrix: one for the blocks of intra type and another for the blocks of inter type. In the example developed below, the residual costs are measured for each of the types corresponding to the quantization matrices.

The coefficients 211 chosen to quantize the data in this first quantization 201 can be predetermined in advance to correspond to an average compromise for all types of video sequence. At the end of the first quantization 201 by these eight respective matrices, eight series of residual costs are obtained, each series comprising the measurements of residual costs for each of the quantized blocks in the corresponding type. Thus, for example, a first series of residual costs is obtained for the blocks of intra 4×4 Y type, a second for the blocks of intra 4×4 U type, etc.

The residual costs belonging to one and the same series can be summed over a reference period, for example a group of images, a group of images comprising a plurality of images of which the first is generally using spatial predictive encoding, the other images of the group being able to comprise temporal predictive encoding blocks based on the blocks included by one or several other images of said group, so that the knowledge of the only images of the group suffices to decode said group. A group of images can for example be an image group in the sense of the H.264 (or MPEG) standard, more commonly designated by the acronym GOP for Group Of Pictures in the H.264 standard. In other words, the first step of quantization 201 can for example be executed on a set of images forming a GOP, so that an overall residual cost can be computed for all the GOP on each of the types of block to be quantized. In the example, eight values of cost are thus obtained for the GOP, each value being equal to the sum of the residual costs respectively obtained in each type of block over all the images of the GOP. These overall residual costs are referenced as follows: C_{INTRA}_{_{—}}_{4×4}_{_{—}}_{Y}, C_{INTRA}_{_{—}}_{4×4}_{_{—}}_{U}, C_{INTRA}_{_{—}}_{4×4}_{_{—}}_{V}, C_{INTER}_{_{—}}_{4×4}_{_{—}}_{Y}, C_{INTER}_{_{—}}_{4×4}_{_{—}}_{U}, C_{INTER}_{_{—}}_{4×4}_{_{—}}_{V}, C_{INTRA}_{_{—}}_{8×8}_{_{—}}_{Y}, C_{INTER}_{_{—}}_{8×8}_{_{—}}_{Y}, each of these costs corresponding to the respective type of block defined above. Other reference periods for computing the residual overall costs may be envisioned, for example a period grouping several GOP, or a period below that of a GOP.

Furthermore, according to one implementation of the method according to the invention, the first quantization 201 is only carried out on a sample of the transformed image blocks 210 supplied as input, the residual costs resulting in this case solely from the quantization of the blocks making up the sample.

Secondly 202, the residual costs determined in the first quantization step 201 are made use of to compute the indicators. These indicators can notably be equal to ratios of residual costs relating to different types.

For example, a first computed indicator I1 can be I1=(C_{INTER}_{_{—}}_{8×8}_{_{—}}_{Y}+C_{INTER}_{_{—}}_{4×4}_{_{—}}_{Y}+C_{INTER}_{_{—}}_{4×4}_{_{—}}_{U}+C_{INTER}_{_{—}}_{4×4}_{_{—}}_{V})/(C_{INTRA}_{_{—}}_{8×8}_{_{—}}_{Y}+C_{INTRA}_{_{—}}_{4×4}_{_{—}}_{Y}+C_{INTRA}_{_{—}}_{4×4}_{_{—}}_{U}+C_{INTRA}_{_{—}}_{4×4}_{_{—}}_{V}), in other words, I1 is equal to the ratio of the residual encoding costs of the blocks of inter mode to the blocks of intra mode. This indicator I1 makes it possible to determine the relative weights of the spatial and temporal information items in the encoding of the images. Another example of an indicator that can be computed is I2=(C_{INTRA}_{_{—}}_{4×4}_{_{—}}_{U}+C_{INTRA}_{_{—}}_{4×4}_{_{—}}_{V}+C_{INTER}_{_{—}}_{4×4}_{_{—}}_{U}+C_{INTER}_{_{—}}_{4×4}_{_{—}}_{V})/(C_{INTRA}_{_{—}}_{4×4}_{_{—}}_{Y}+C_{INTER}_{_{—}}_{4×4}_{_{—}}_{Y}+C_{INTRA}_{_{—}}_{8×8}_{_{—}}_{Y}+C_{INTER}_{_{—}}_{8×8}_{_{—}}_{Y}), in other words the ratio of the residual encoding costs of the chrominance blocks to the luminance blocks. This indicator I2 makes it possible to determine the relative weights of the items of chrominance and luminance information in the encoding of the images. Other indicators can also be computed to determine the information density of certain types of block compared to other types. The indicators therefore make it possible to at least partly know the distribution of the residual costs between the various types of block to be encoded.

Thirdly 203, the indicators determined in the previous step 202 are made use of to choose sets of coefficients to be used in the quantization of the data. The coefficients are chosen as a function of the indicators and of psycho-visual criteria to improve the visual rendition of the video.

By way of illustration, to return to the aforementioned indicator I1, if the ratio I1 of the residual encoding costs of the blocks of inter mode to the blocks of intra mode is high, this means that the image sequence is complex from the temporal point of view. For example, the scene represented by the image sequence comprises objects in motion, many texture details of which the human eye is not able to perceive. In this type of sequence, the human visual system applies an integrating filter that ignores the many details in the bodies in motion, but is sensitive to the fluidity of the motion. In such a case, a stricter quantization is preferably applied to the information encoded in intra mode to leave enough bitrate available for the information encoded in inter mode and thus better preserve the motion. Also, in order to reserve the available bandwidth for the encoding of the inter information as a matter of priority, the coefficients of the quantization matrices corresponding to the Intra types are increased and those corresponding to the Inter types are decreased. In the example, the coefficients of the matrices relating to the types of block Intra 4×4 Y, Intra 4×4 Chroma U, Intra 4×4 Chroma V and Intra 8×8 Y are increased and those of the matrices Inter 4×4 Y, Inter 4×4 Chroma U, Inter 4×4 Chroma V and Inter 8×8 Y are decreased. If, on the contrary, this ratio 11 is low—for example, if the image sequence to be encoded represents a scene with little motion—preservation of the intra data should be privileged and the coefficients of the matrices of Intra type are decreased, the coefficients of Inter type being increased by way of compensation. In this way, the quality of the details is improved for the whole scene, because the better quality of the reference image encoded in Intra propagates to the temporal prediction images, which benefit from a simple temporal prediction in this type of sequence.

According to another illustration based on the indicator I2, if the ratio 12 of the residual encoding costs of the chrominance blocks to the luminance blocks is low, then preservation of the colors is essential, because the color artifacts are more perceptible by a human observer in image sequences with low chromatic content. In addition, the coefficients corresponding to the lower-order coefficients of the matrices relating to the types of block Intra 4×4 Chroma U, Intra 4×4 Chroma V, Inter 4×4 Chroma U and Inter 4×4 Chroma V are decreased.

According to one implementation of the method according to the invention, several sets of quantization matrices are predetermined and selectable as a function of the indicators, one set of matrices comprising, in the example, eight quantization matrices. For example, if two indicators I1 and I2 are determined in the preceding step 202, the chosen set of matrices can depend jointly on the values of I1 and I2. The domain of the values of each indicator is partitioned into several intervals, so that the values of the coefficients of the matrices are different when the value of an indicator passes from one interval to another. One set of matrices per pair of intervals can thus be prepared in advance, so that in the general case, the number of sets available for the second quantization 204 is equal to the product of the number of intervals in each domain of values of the indicators. In the example, if two intervals are defined for I1 and three intervals are defined for I2, then six sets of matrices can be defined. In a special case, only one threshold value is defined for each indicator, in which case a maximum of 2^{number of indicators} is defined and the most suitable set of matrices is chosen after comparison with each indicator threshold.

According to another implementation of the method according to the invention, the sets of matrices are not pre-computed and the coefficients of the matrices are computed on the fly as a function of the values of the indicators.

According to another implementation of the method according to the invention, the coefficients of quantization are chosen directly on the basis of the residual costs computed on the basis of the first quantization 201; in other words, no intermediate indicator is computed.

Fourthly, a second quantization 204 is carried out on the input data using the quantization coefficients determined in the preceding step 203.

In the aforementioned example, the set of eight matrices corresponding to the indicator values obtained is used for the second quantization 204. The input data that had been quantified in the first quantization 201 are delayed for a reference period—in the example, one GOP—in such a way as to quantize these same input data with the set of matrices chosen as a function of the indicators and not with the predetermined set of matrices used in the first pass of quantization 201.

According to one implementation of the method according to the invention, only certain types of block, or even a single block, are subject to a dynamic quantization. In the aforementioned example, it is for example envisionable to make the quantization of all the blocks of “inter 4×4 chroma U” type dynamic, and to make it dynamic for these blocks only, the other types of block being quantized according to a conventional method. Nonetheless, in this example, although only one type of block is quantized dynamically, this dynamic quantization depends on the distribution of the residual costs between the different types of block, to evaluate their relative levels of complexity and allocate more bitrate for the more complex and critical components from the point of view of visual rendition.

Furthermore, in conformance with conventional encoding techniques, the bitrate of output data can be regulated, for example, by a quantization increment adjusted as a function of the bandwidth allocated to the output stream. The video stream 240 resulting from the second quantization step 204 can then be the subject of entropy encoding to complete the compression and produce an output MPEG stream. Thus, the term “quantization coefficient” should be understood to mean the factor of a coefficient used for quantizing the data; this “quantization coefficient” being able to be multiplied by a scalar quantization increment to adapt the bitrate of the output data.

The dynamic quantization method according to the invention can be applied cyclically to a video stream to be encoded. The quantization matrices are updated with a period equal to the reference period mentioned earlier, for example one GOP. In other words, the method cyclically applies a first quantization pass with a set of predefined and fixed matrices with the aim of determining residual encoding costs for several types of block, then applies to the same stream a second quantization step 204 with matrices with carefully chosen coefficients.

An MPEG encoder can thus be configured to execute a dynamic quantization method in the place of a conventional quantization method, in such a way as to preserve a better visual rendition with an equivalent level of compression, or to obtain a better level of compression with equivalent quality.

The encoder can comprise a memory storing the various sets of quantization coefficients liable to be used, a computing unit (programmable circuit for example) configured to compute the residual costs and relative cost indicators and to choose the most suitable set of coefficients.

Moreover, the encoder can insert the quantization matrices into the output stream, in such a way that a decoder receiving this stream can use these matrices to decode the blocks. According to one embodiment of the encoder according to the invention, the encoder includes a memory storing the various sets of matrices available for the quantization and inserts, into the output stream (resulting from the quantization), an identifier of the set of matrices used for the quantization. An associated decoder stores equivalent matrices in a memory and makes use of the identifier present in the stream to retrieve the set of matrices that have been used for the quantization.

The dynamic quantization method according to the invention makes it possible to modify assignments of bandwidth between the different types of data to be encoded as a function of the relative importance of each of these data items to the preservation of the video quality. It also makes it possible to modify the bitrate distribution for one and the same type of block by increasing or decreasing certain quantization coefficients as a function of the distribution of the residual costs due to different types of block.

The dynamic quantization method according to the invention makes it possible to adapt the levels of quantization applied to certain visual parameters (for example the chrominance) as a function of the relative evolution of other visual parameters (for example the luminance).

The dynamic quantization method according to the invention can for example be employed in the H.264/MPEG4-AVC encoders of HD (high definition) or SD (standard definition) video streams, without however being limited to the H.264 standard, it being possible to make more general use of the method when encoding streams including several types of data (inter or intra, luminance or chrominance for example), whether these data items are images, image slices, or more generally sets of pixels that can take the form of blocks. Each of these data items comprising information of different types can then be the subject of quantization optimized according to the relative residual costs between the various types of data. The method according to the invention is also applicable to encoded streams of other standards than MPEG2.

1-15. (canceled)

16. A method of dynamic quantization of a stream of images including blocks of different types transposed into the transform domain, the method comprising:
a first step of quantization of several of said blocks with initial quantization coefficients;
a step of determination, for several types of block respectively, of the residual encoding costs after said first quantization;
a second step of quantization of the transposed blocks of at least one type with quantization coefficients chosen according to the distribution of said residual costs between several types of block.

17. The method of claim 16, wherein a plurality of sets of coefficients is pre-computed and coefficients of a set chosen from among said plurality are applied in the second quantization step.

18. The method of claim 17, wherein one indicator or several indicators of distribution of the residual costs between several types of block is computed, the domain of definition of said indicators is partitioned into a plurality of domains of values, a set of pre-computed coefficients is associated to each of said domains, and the set of coefficients to be applied in the second quantization step is chosen from among said sets as a function of the value of said indicators.

19. The method of claim 16, wherein the blocks quantized in the first quantization step comprise chrominance blocks and luminance blocks transposed into the transform domain, and wherein the quantization coefficients applied in the second step are chosen at least partly as a function of the ratio of the residual costs due to the chrominance blocks to the residual costs due to the luminance blocks.

20. The method of claim 19, wherein, in the second quantization step, the quantization coefficients associated with the components corresponding to a frequency below or equal to a predetermined value in the chrominance blocks are decreased, in relation to the decrease in the residual costs due to the chrominance blocks with respect to the residual costs due to the luminance blocks.

21. The method of claim 16, wherein the blocks quantized in the first quantization step comprise spatial predictive encoding blocks and temporal predictive encoding blocks transposed into the transform domain, and wherein the quantization coefficients applied in the second step are chosen at least partly as a function of the ratio of the residual costs due to the spatial predictive encoding blocks to the residual costs due to the temporal predictive encoding blocks.

22. The method of claim 21, wherein, in the second quantization step, the quantization coefficients associated with the spatial predictive encoding blocks are decreased, and the quantization coefficients associated with the temporal predictive encoding blocks are increased, in relation to the decrease in the residual costs due to the temporal predictive encoding blocks with respect to the residual costs due to the spatial predictive encoding blocks.

23. The method of claim 16, wherein the quantization coefficients applied in the second quantization step to a single type of block or to a single set of types of block are grouped and stored in the memory in a quantization matrix.

24. The method of claim 23, wherein the stream is to be encoded to the MPEG standard, wherein a set of quantization matrices chosen dynamically as a function of the distribution of the residual costs comprises:
three matrices intended for the quantization of the spatial predictive encoding blocks of a dimension of 4×4 pixels, among which two are intended for the chrominance blocks and one is intended for the luminance blocks;
three matrices intended for the quantization of the temporal predictive encoding blocks of a dimension of 4×4 pixels, among which two are intended for the chrominance blocks and one is intended for the luminance blocks; and
two matrices intended for the quantization of the luminance blocks of a dimension of 8×8 pixels, among which are the spatial predictive encoding blocks and the temporal predictive encoding blocks.

25. A method for encoding a stream of images forming a video, comprising a step of transforming the images by blocks into the transform domain, wherein a dynamic quantization method is executed on said blocks as claimed in claim 16.

26. The method of claim 25, wherein the stream is encoded according to an MPEG standard.

27. The method of claim 26, wherein the dynamic quantization method is applied cyclically over a reference period equal to one group of MPEG images.

28. A video encoder, configured to execute the encoding method as claimed in claim 26.

29. A video encoder, configured to execute the encoding method as claimed in claim 27.

30. A method for decoding a stream of images encoded by an MPEG encoder as claimed in claim 28, the decoder being configured to retrieve, from said encoded stream of images, the quantization coefficients used by the encoder to quantize the blocks of data.

31. An MPEG video decoder, configured to execute the decoding method as claimed in claim 30.
